(19) United States
(12) Patent Application Publication
(10) Pub. No.: US 2010/0111166 A1
(43) Pub. Date: May 6, 2010

(54) DEVICE FOR DECODING A VIDEO STREAM AND METHOD THEREOF

(75) Inventors: Erik M. Schlanger, Austin, TX (US); Brendan D. Donahe, Lago Vista, TX (US); Eric Swartzendruber, Round Rock, TX (US); Sandip J. Ladhani, Austin, TX (US)

Correspondence Address: Vista IP Law Group LLP, 1885 Lundy Avenue Suite 108, San Jose, CA, 95131, US

(73) Assignee: RMI CORPORATION, Cupertino, CA (US)

(21) Appl. No.: 12/262,211

(22) Filed: Oct. 31, 2008

(51) Int. Cl. H04N 7/32

(52) U.S. Cl. 375/240.12; 375/E07.125

(57) ABSTRACT

A device is disclosed having a motion vector processing module to determine a first set of motion vectors associated with a macroblock of a video picture. A motion vector reduction module determines a second set of motion vectors, based on the first set of motion vectors, associated the macroblock, the second set having fewer motion vectors than the first set. A decode module comprising an input completes decoding of the macroblock based upon the second set of motion vectors

### BACKGROUND

1. Field of the Disclosure

The present disclosure is related to data processing and more particularly to processing of video information.

2. Description of the Related Art

Video information is commonly compressed to take advantage of portions of images that are repeated. For example, the amount of video data that is needed to represent an image can be reduced by processing images based upon motion vectors. Motion vectors identify an area of a previously processed picture having an image that is the same or similar to a corresponding area of a picture currently being processed. However, there is a cost in terms of needed processing power and data bandwidth needed to process images that are based upon motion vectors. Therefore, it will be appreciated that reducing the number of motion vectors associated with a specific image can result in a reduction of needed processing and data bandwidth in certain systems.

### BRIEF DESCRIPTION OF THE DRAWINGS

The present disclosure may be better understood, and its numerous features and advantages made apparent to those skilled in the art by referencing the accompanying drawings.

FIG. 1 illustrates a block diagram in accordance with a specific embodiment of the present disclosure;

FIG. 2 illustrates a block diagram of a portion of FIG. 1 in greater detail in accordance with a specific embodiment of the present disclosure;

FIG. 3 illustrates a block diagram a portion of FIG. 2 in greater detail in accordance with a specific embodiment of the present disclosure;

FIG. 4 illustrates a flow diagram in greater detail in accordance with a specific embodiment of the present disclosure;

FIG. 5 illustrates a table representing data associated with a specific macroblock in accordance with a specific embodiment of the present disclosure;

FIG. 6 illustrates a macroblock partitioned to have four 8×8 image block;

FIG. 7 illustrates a macroblock of FIG. 6 further partitioned such that each 8×8 image block include four 4×4 image blocks;

FIG. 8 illustrates a flow diagram of a portion of FIG. 4 in greater detail in accordance with a specific embodiment of the present disclosure;

FIG. 9 illustrates the table of FIG. 5 after a portion of the macroblock information has been modified in accordance with a specific embodiment of the present disclosure;

FIG. 10 illustrates the table of FIG. 9 after a portion of the macroblock information has been modified in accordance with a specific embodiment of the present disclosure;

FIG. 11 illustrates a flow diagram of a portion of FIG. 4 in greater detail in accordance with a specific embodiment of the present disclosure;

FIG. 12 illustrates the table of FIG. 10 after a portion of the macroblock information has been modified in accordance with a specific embodiment of the present disclosure;

FIG. 13 illustrates a table representing data associated with a specific macroblock in accordance with a specific embodiment of the present disclosure;

FIG. 14 illustrates the table of FIG. 13 after a portion of the macroblock information has been modified in accordance with a specific embodiment of the present disclosure;

FIG. 15 illustrates a table representing data associated with a specific macroblock in accordance with a specific embodiment of the present disclosure;

FIG. 16 illustrates the table of FIG. 15 after a portion of the macroblock information has been modified in accordance with a specific embodiment of the present disclosure;

FIG. 17 illustrates a table representing data associated with a specific macroblock in accordance with a specific embodiment of the present disclosure;

FIG. 18 illustrates the table of FIG. 17 after a portion of the macroblock information has been modified in accordance with a specific embodiment of the present disclosure;

FIG. 19 illustrates the table of FIG. 18 after a portion of the macroblock information has been modified in accordance with a specific embodiment of the present disclosure;

FIG. 20 illustrates a flow diagram in accordance with a specific embodiment of the present disclosure;

### DETAILED DESCRIPTION

A device is disclosed having a motion vector processing module that can remove motion vectors from a video stream that is to be rendered. For example, a first set of motion vectors associated with a macroblock of the video picture is determined. A motion vector reduction module determines a second set of motion vectors, based on the first set of motion vectors, representing the macroblock, the second set having fewer motion vectors than the first set. A decode module comprising an input completes decoding of the macroblock based upon the second set of motion vectors prior to rendering the image.

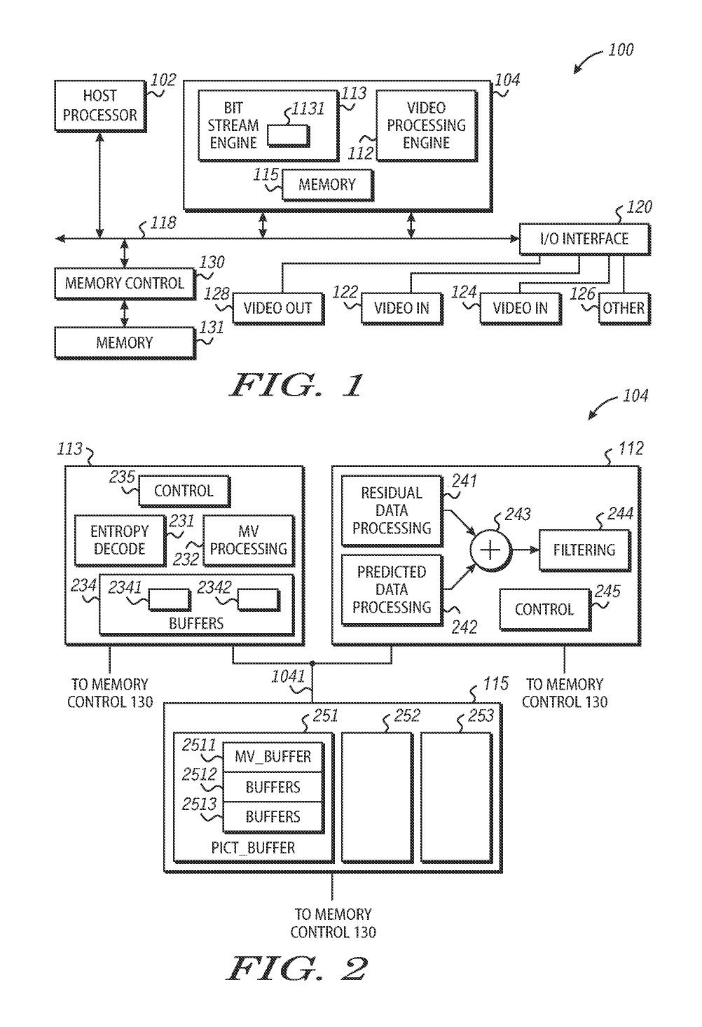

FIG. 1 is a block diagram of a video processing system of a device 100 according to a particular embodiment of the disclosure. The device 100 that includes the video processing system illustrated at FIG. 1 can be an integrated circuit or a device including an integrated circuit that includes the video processing system illustrated at FIG. 1. For example, device 100 can be a handheld electronic device having a self contained power supply. The device 100 can be a video processing system that can process various digital video standards such as h.264, MPEG (“Moving Pictures Expert Group”) 1, 2, and 4, JPEG (Joint Picture Experts Group), MJPEG (“Motion JPEG”), DV (“Digital Video”), WMV (“Windows Media Video”), VC-1, RM (“Real Media”), DivX, Sorenson 3, Quicktime 6, RP9, WMV9, AVS, Ogg Theora, Dirac, or various other formats and code/decode specifications (codecs).

The video processing system illustrated at FIG. 1 includes a host processor 102, an image decoder engine (IDE) 104, I/O interface module 120, video-in module 122, video-in module 124, video out-module 128, other modules 126, memory control module 130, and memory 131. An interconnect 118 connects the host processor 102, IDE 104, I/O interface 120, and memory control module 130 to facilitate the communication of information.

The host processor 102 is operable as an instruction based data processor that can include one or more core processors capable of executing an operating system, software applications, and the like. The memory control module 130 is operable to access information from memory 131 in response to memory access requests received from host processor 102. Memory control module 130 can be a direct memory access (DMA) controller operable to transfer memory between various memories and modules of FIG. 1. I/O interface 120 can be a memory controller, such as a DMA controller operable to provide information between various modules of FIG. 1, such as between video in module 122 and the IDE 104, or between video in module 122 and memory 131. During operation, a video stream from a video source, such as memory 131 or form video in module 128, is received at IDE 104 for decoding. The decoded video that can be displayed by a render engine (not illustrated) is provided to a destination, such as memory 131 or to video out module 128.

IDE 104 includes a bit stream engine 113, a video processing engine 112, and a memory 115. In one embodiment, memory 115 is local to IDE 104 in that it can be accessed by portions of IDE 104, such as bit stream engine 113 and video processing engine 112. In an alternate embodiment, memory 115 can represent separate memory locations (not specifically illustrated) whereby a first portion of memory 115 would be local to the bit stream engine 113 and a second portion of memory 115 would be local to the video processing engine 112, whereby the portions of memory 115 that support the bit stream engine 113 would not be accessible by the video processing engine 112, and similarly the portion of memory 115 that would support video processing engine 112 would not be accessible to memory 113. In this embodiment, data transfer between bit stream engine 113 and video processing engine 112 would occur through memory control 130 and memory 131.

During operation, entropy decoding of the video stream is performed and motion vectors of the video stream are determined at the bit stream engine 113. The bit stream engine 113 includes a motion vector reduction module 1131 that reduces the number of motion vectors of the video stream that are decoded by the bit stream engine 113 before being used for further decoding by the video processing engine 112. The video processing system of FIG. 1 will be better understood with reference to FIGS. 2-20

FIG. 2 illustrates portions of the bit stream engine 113, video processing engine 112, and memory 115 of FIG. 1 in greater detail. The bit stream engine includes an entropy decode module 231, a motion vector processing module 232, control module 235, and memory 234, which includes buffers 2341 and 2342 that are implemented using memory 115. FIG. 2 illustrates a specific embodiment, where information from bit stream module 113 is provided to video processing engine 112 through memory 115. In an alternate embodiment, memory 215 is local to bit stream module 113 and not accessible to the video processing engine. Therefore, information from bit stream module 113 is provided to video processing engine 112 through memory control module 130 and memory 131. For example, buffer information for a macroblock can be transferred by direct memory access from memory 234 to memory 131 when processing by the bit stream engine is complete and subsequently transferred by direct memory access from memory 131 to a memory accessible by the video processing engine 112.

Entropy decode module 231 performs entropy decoding on the video stream and stores the entropy decoded information in the buffers 234. For example, with a video stream based upon the h.264 standard, the entropy decoder can implement entropy decoding based upon context-adaptive binary arithmetic encoding or context-adaptive variable length coding, and store various types of video information used for further downstream decoding at corresponding buffers of buffers 234. For example, buffer 2341 of buffers 234 represents a buffer where motion vector information received via the video stream is stored after any entropy decoding. For purposes of discussion, it is assumed that picture information received via the video stream is processed on a macroblock by macroblock basis, and that buffer 2341 of the buffers 234 stores motion vector information related to one macroblock of the picture being processed.

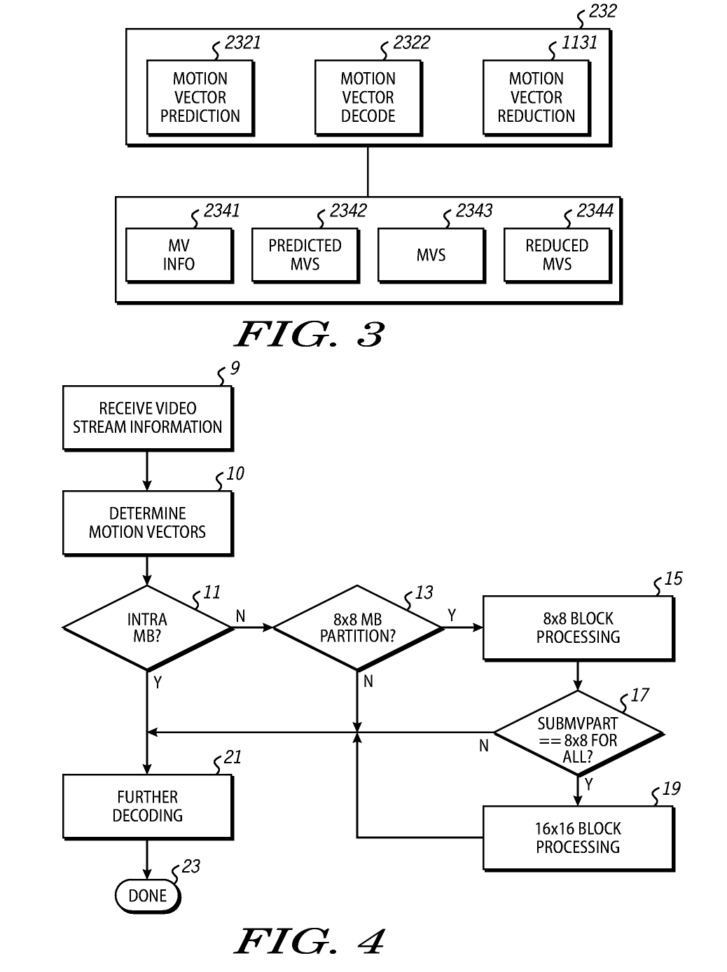

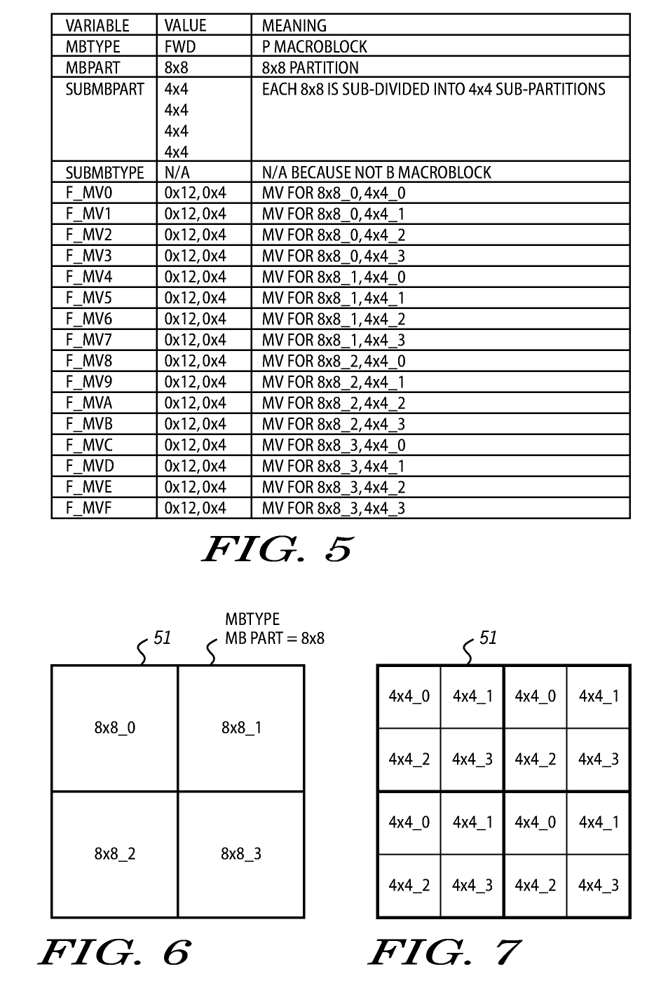

Motion vector processing module 232 determines motion vectors for each macroblock based upon the motion vector information stored at buffer 2341 as will be discussed in greater detail with respect to FIG. 3. Control module 235 represents control logic that coordinates the flow of information associated with bit stream engine 113. For example, module 235 can be a state machine or instruction based processor.

FIG. 3 illustrates a more detailed view of motion vector processing module 232 and buffers 234 in accordance with a specific embodiment. Motion vector processing module 232 includes motion vector prediction module 2321, motion vector decode module 2322, and motion vector reduction module 1131.

During operation, motion vector prediction module 2321 can predict initial motion vectors for video blocks of a macroblock. Depending upon a specific standard used to encode a video stream, the motion vector prediction can be unidirectional or bidirectional. A unidirectional motion vector prediction uses either a forward motion vector or a backward motion vector to identify a single reference picture to predict a motion vector for an image block, where a forward motion vector points to a location within a reference picture that proceeds the picture being processed in render order, while a backward motion vector is a motion vector that follows the picture being processed in render order. A bidirectional motion vector prediction includes both a forward and a backward motion vector to identify two reference pictures to predict a motion vector for an image block. The predicted motion vectors for each macroblock are stored at the buffers 234. For example, the predicted motion vectors can be stored at buffer 2342.

The motion vector decode module 2322 combines the predicted motion vector information, stored at 2342, with the residual motion vector information stored at buffer 2341 to generate the actual motion vectors. The actual motion vectors are stored at buffer 2343. Depending upon the compression algorithm used to generate the encoded motion vectors, there may be image blocks that have the same motion vector that can be combined. Therefore, the motion vectors associated with a macroblock can be analyzed to determine if they can be combined into a larger block.

The processing and memory access bandwidth of the down stream portion of the video processing system needs to be robust enough to process each image block of a picture. Therefore, reducing the number of motion vectors associated with a picture can result in a less costly system.

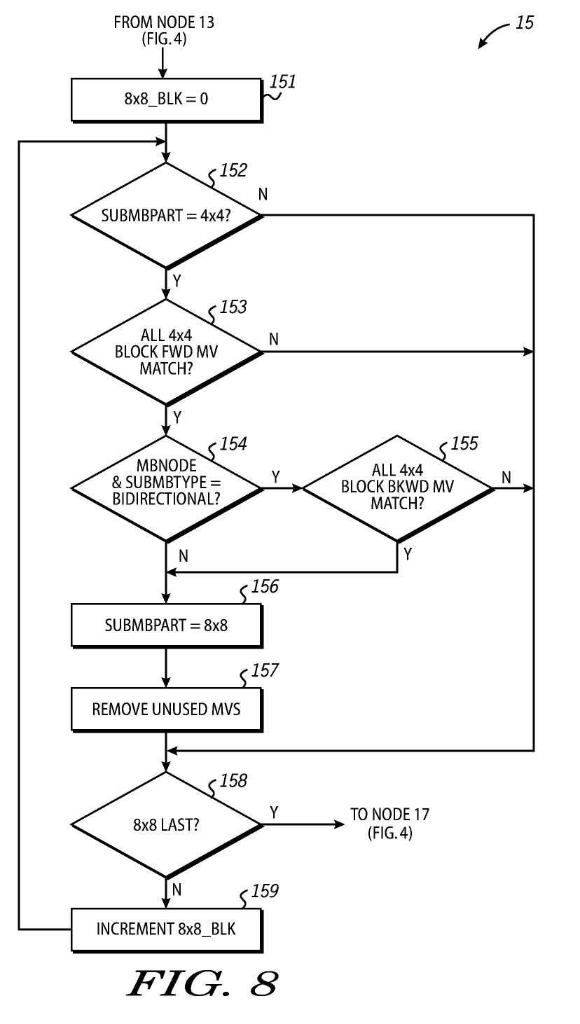

Operation of the motion vector reduction module 1131 will be better understood with reference to FIGS. 4-20.

FIG. 4 illustrates a flow diagram in accordance with a specific embodiment of the present disclosure. At node 9, video stream information is received that includes encoded video picture information, as previously discussed, where each encoded video picture includes a plurality of encoded macroblocks. At node 10, motion vectors and other video stream information based upon the video stream information is determined. For example, the motion vectors for the blocks of each macroblock can be determined by the motion vector decode module 2322 as previously described and as represented at the table of FIG. 5.

FIG. 5 illustrates a table including video stream information related to a specific macroblock being decoded. The first column of FIG. 5 lists various variables associated with the macroblock, the second column lists various values corresponding to the variables of column 1, and column 3 includes a short description related to the corresponding variables of column 1.

The first record of the table of FIG. 5 represents a variable labeled MBTYPE that indicates the macroblock's type. Various macroblock types can include an intra image macroblock that is not predicted using previously decoded reference frames vectors, a unidirectional predicted macroblock, such as a forward predicted macroblock (FWD) or a backward predicted macroblock (BWD) that is predicted using a single previously decoded reference pictures, and a bidirectional predicted macroblock (BDIR) that is predicted using two previously decoded reference pictures. A macroblock that can include both unidirectional predicted blocks and bidirectional predicted blocks is marked as being of type BDIR. The variable MBTYPE of the macroblock represented by table 5 is FWD, which can represent a macroblock commonly referred to as a P-type macroblock as indicated in the description column. FIG. 6 illustrates a macroblock associated with variable MBTYPE. For purposes of discussion it is assumed a macroblock is an array of sixteen pixels by sixteen pixels.

The second record of the table of FIG. 5 represents a variable labeled MBPART that indicates the macroblock's partitioning, thereby indicating a number and configuration of picture blocks of the macroblock. Various macroblock partitions that can be indicated by variable MBPART include a 16×16 partition, two 16×8 partitions, two 8×16 partitions, or four 8×8 partitions. The variable MBPART of the macroblock represented by is 8×8, thereby indicating there are four 8×8 partitions in the macroblock represented by FIG. 5. The macroblock 51 illustrated at FIG. 6 is sub-divided into four 8×8 blocks to illustrate that it is partitioned based upon variable MBPART having a value of 8×8.

The third record of the table of FIG. 5 represents a set of variables labeled SUBMBPART that indicates a sub partitioning the blocks of a macroblock. For example, for encoding based upon h.264 encoding, the variable SUBMBPART is only needed when the value of MBPART is 8×8 to indicate whether each 8×8 block is further subdivided. Sub block partition types can include 8×8, 8×4, 4×8, and 4×4 partitions, where a value of 8×8 indicates a particular 8×8 block is not further divided. The variable SUBMBPART of FIG. 5 is equal to 4×4, 4×4, 4×4, 4×4 to indicate each 8×8 block of the macroblock is further partitioned as four 4×4 blocks. FIG. 7 illustrates the macroblock of FIG. 6 having each of its 8×8 blocks sub-divided into 4×4 blocks based upon the variable SUBMBPART being equal to 4×4, 4×4, 4×4, 4×4. The top left 4×4 block of the macroblock of FIG. 7 can be referred to as 4×4 block 8×8_{—}0/4×4_{—}0.

The fourth record of the table of FIG. 5 represents a set of information labeled SUBMBTYPE that further indicates a block type of each block within the macroblock. In one embodiment, for encoding standards that allow image blocks within a macroblock to have different types of motion prediction, the default block type within a macroblock is the type specified by MBTYPE, however, when MBTYPE is BDIR the variable SUBMBTYPE can override the default type of a block by block basis. For example, the variable SUBMBTYPE can be used to indicate a specific block is a unidirectional block, such as a forward or backward block, when variable MBTYPE indicates the presence of bidirectional blocks. The set of information associated with SUBMBTYPE of FIG. 5 is not applicable since MBTYPE is not equal to BDIR.

The remaining records, labeled F_MV0-F_MVF, indicate specific forward motion vectors for each block of the macroblock represented as X and Y coordinates. Note that each block's motion vector(s) is also associated with a reference picture that can vary from block to block, however, for purposes of discussion it is assumed that each of the motion vectors F_MV0-F_MVF point to the same reference picture and therefore are not illustrated at FIG. 5. In alternate embodiments, the motion vectors MV0-MVF can reference two or more different reference pictures, which could be indicated at the table of FIG. 5. For purposes of discussion herein, forward motion vectors are identified as starting with the prefix “F_”, while backward motion vectors are identified as staring with the prefix “B_”.

Flow proceeds to node 11 once the motion vectors are determined at node 10, where it is determined whether or not the current macroblock is an intra macroblock. This can be determined based upon the variable MBTYPE, which for the example of FIG. 5 indicates the current macroblock, is a unidirectional macroblock having forward motion vectors. Flow proceeds to node 21 if the current macroblock is an intra type macroblock, otherwise flow proceeds to node 13.

At node 13, it is determined whether the partitioning of the current macroblock is 8×8 partitioning. This can be determined based upon the variable MBPART, which for the example of FIG. 5 indicates the macroblock is partitioned into four 8×8 partitions. Flow proceeds to node 15 if the current macroblock's partitioning is 8×8, otherwise flow proceeds to node 21.

At node 15, further processing of the 8×8 blocks is performed to determine if any motion vectors for the current macroblock can be eliminated. A specific embodiment of evaluating the 8×8 blocks is further described at FIG. 8.

FIG. 8 illustrates a flow diagram representing a more detailed view of node 15 of FIG. 4 in accordance with a specific embodiment of the present disclosure where it is determined whether the 8×8 blocks of the macroblock are further portioned into 4×4 blocks, and if so, whether they can be combined in to a larger blocks, such as a single 16×16 block. At node 151 of FIG. 8, the first of four 8×8 blocks of the macroblock is identified as the current block for processing.

At node 152 it is determined if the current 8×8 block includes four 4×4 blocks. If so, the flow proceeds to node 153, otherwise the flow proceeds to node 158. Whether the current block includes all 4×4 blocks can be determined for the first 8×8 block of the macroblock based upon the first entry listed for variable SUBMBPART at the table of FIG. 5, which indicates the partitioning of the first block is 4×4.

At block 153 a determination is made whether the unidirectional motion vectors, e.g., forward motion vectors, of each block of the 4×4 blocks of the current 8×8 block are the same. For example, referring to the table of FIG. 5, each of the motion vectors F_MV0-F_MV3 for the 8×8 block labeled 8×8_{—}0 are unidirectional motion vectors with the same X and Y value indicating that they are the same. For purposes of discussion, the unidirectional motion vectors are presumed to be forward motion vectors, and they are also presumed to reference the same reference picture. In response to each of the four 4×4 blocks of the current macroblock represented by the table of FIG. 5 having the same motion vector, flow proceeds to node 154. Had any of the motion vectors F_MV0-F_MV3 been different flow would proceed to node 158.

At node 154 a determination is made whether each of the four 4×4 blocks of the current 8×8 block are bidirectional motion vectors. If so, flow proceeds to node 155, otherwise the flow proceeds to node 156. Whether the four 4×4 blocks of the current 8×8 area are all bidirectional macroblocks can be determined based upon the entry listed for variable MBTYPE, which indicates the block type for each block associated with the first 8×8 macroblock. With respect to the macroblock represented at the table of FIG. 5, each block has a motion vector type defined by the default value, which indicates that each of the four 8×8 blocks have the same type, a forward motion vector type, as the macroblock, specified by MBTYPE.

At node 155, a determination is made whether the backward motion vectors for each of the four 4×4 blocks of the current macroblock are the same. Flow proceeds to node 156 in response to each of the four 4×4 blocks of the current macroblock having the same backward motion vector, otherwise flow proceeds to node 158.

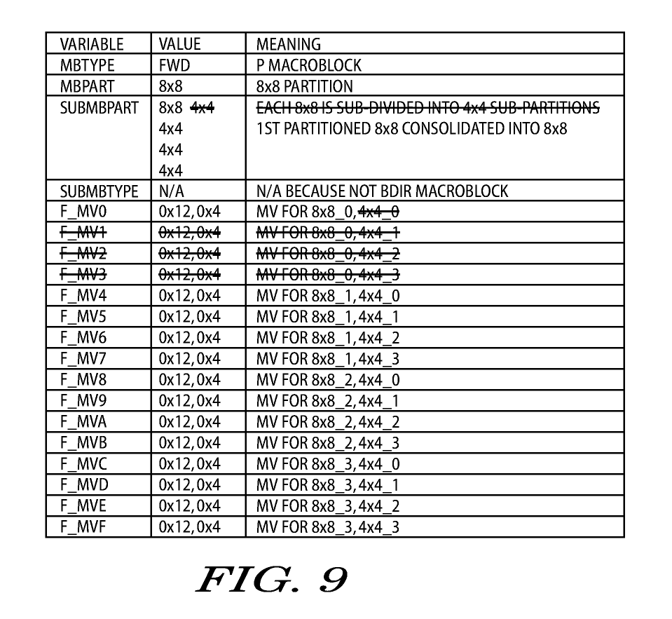

By transitioning to node 156, it has been determined that all four of the 4×4 blocks have the same motion vectors. Therefore, at node 156, the variable SUBMBPART for the current 8×8 macroblock is changed from 4×4 to 8×8 as indicated at the table of FIG. 9 to indicate the first 8×8 block of the current macroblock is now an 8×8 block.

Flow proceeds from 156 to node 157. At node 157 three unneeded motion vectors are be removed as they are no longer needed since the four 4×4 blocks have been combined into one 8×8 block. This is represented at table of FIG. 9, where the motion vector variables labeled F_MV0-F_MV3 have been struck-through.

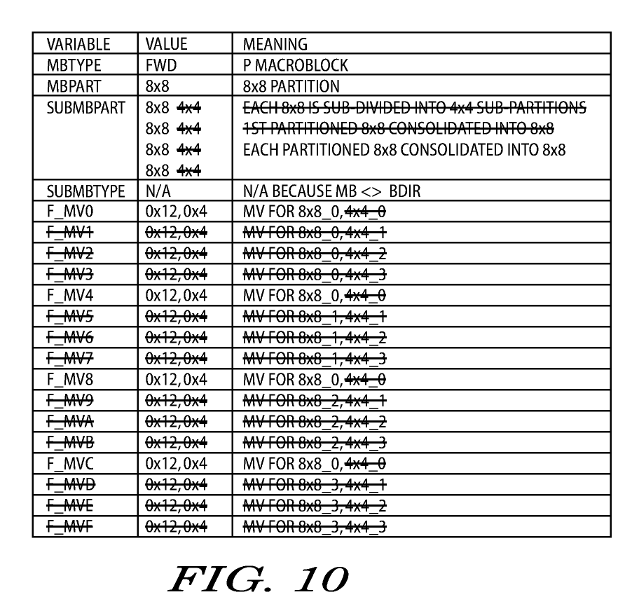

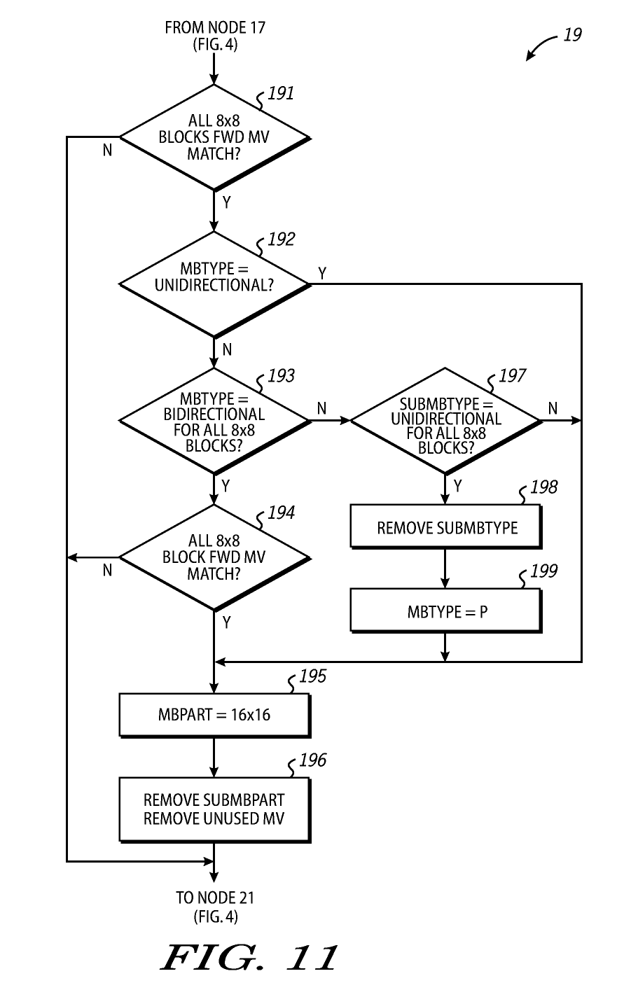

Flow proceeds from node 157 to node 158 where it is determined whether the current 8×8 block of the four 8×8 macroblocks is the last 8×8 block of the current macroblock. If so, flow proceeds to node 159 where the current 8×8 macroblock is identified before flow returns to node 152, otherwise the flow proceeds to node 17 of FIG. 4, whereby processing of node 15 of FIG. 4 is completed. Based upon the macroblock information of FIG. 5, flow will return to node 152 three additional times to process each remaining one of the four 8×8 blocks of the macroblock. Based upon the macroblock data represented at FIG. 5, each subsequent pass through the flow diagram of FIG. 4 will result in each of the other three 8×8 blocks of the macroblock represented by the table of FIG. 5 being processed identically as the first 8×8 block. The current macroblock is represented by the table of FIG. 10 after processing of each 8×8 block has been completed, where motion vectors F_MV5-F_MV7, F_MV9-F_MVB, and F_MVD-F_MVF have been struck through, and where the variable SUBMBPART has been updated to 8×8, 8×8, 8×8, and 8×8 to indicate each 8×8 block of the macroblock has a sub partition type.

Returning to FIG. 4, flow proceeds at node 17, where it is determined whether the sub partition type, SUBMBPART, of each 8×8 block of the current macroblock is also 8×8. If so, flow proceeds to node 19, otherwise the flow proceeds to node 21. With respect to the current macroblock as represented by the table of FIG. 10, each of the four 8×8 macroblock also has a sub partition type of 8×8 so flow proceeds to node 19.

FIG. 11 illustrates a flow diagram representing a more detailed view of node 19 of FIG. 4 in accordance with a specific embodiment of the present disclosure. At node 191, a determination is made whether the forward motion vectors for each of the four 8×8 blocks of the current macroblock are the same. For example, referring to the table of FIG. 10, each of the motion vectors F_MV0, F_MV4, F_MV8, and F_MVC have unidirectional motion vectors, forward motion vectors with the same X and Y values, thereby indicating that their motion vectors are the same. For purposes of discussion, the unidirectional motion vectors are presumed to be forward motion vectors. In response to each of the four 8×8 blocks of the current macroblock having the same motion vector, flow proceeds to node 192, otherwise flow returns to FIG. 4.

At node 192 a determination is made whether each of the four 8×8 blocks of the current 8×8 blocks are of the same unidirectional type, such as forward motion vectors. If so, flow proceeds to node 195, otherwise flow proceeds to node 193.

At node 193, a determination is made whether each of the four 8×8 blocks of the macroblock have sub block partition type, SUBMBTYPE, of bidirectional. If so, flow proceeds to node 194, otherwise flow proceeds to node 197.

At node 194, a determination is made whether the other set of unidirectional motion vectors, such as backward motion vectors, for each of the four 8×8 blocks of the current macroblock are the same. Flow proceeds to node 195 in response to each of the four 8×8 blocks of the current macroblock having the same backward motion vector, otherwise flow returns to FIG. 4.

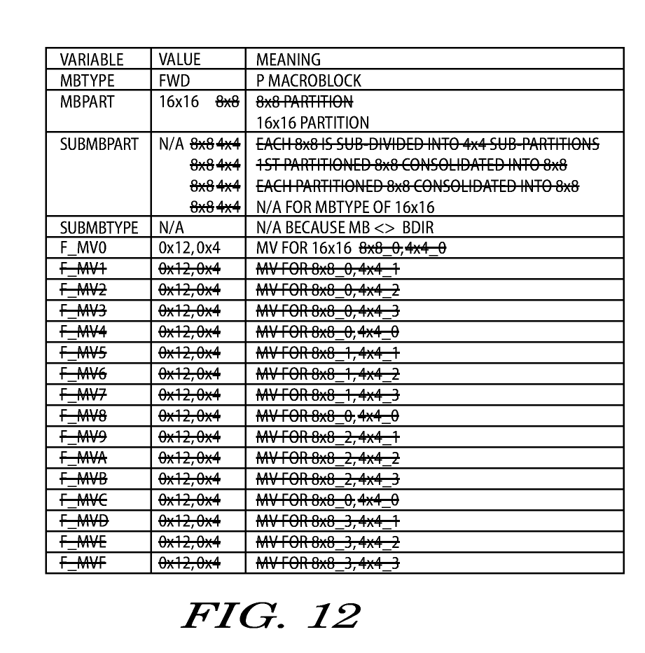

By transitioning to node 195, it has been determined that each of the four 8×8 blocks of the macroblock have the same motion vector. Therefore, the four 8×8 motion vectors can be represented by a single 16×16 block by changing the variable MBPART from 8×8 to 16×16 as indicated at FIG. 12.

Flow proceeds from 195 to node 196, where three unneeded motion vectors, F_MV4, F_MV8, and F_MVC are removed as a result of the four 8×8 blocks being combined into one 16×16 block. This is represented at table of FIG. 12, where the motion vector variables labeled, F_MV4, F_MV8, and F_MVC have been struck-through, and the variable SUBMBPART has been updated to indicate its data is not applicable (N/A), since the macroblock is not partitioned as 8×8 blocks.

At node 197, a determination is made whether each of the four 8×8 blocks of the macroblock have a common unidirectional sub block partition type, SUBMBTYPE, such as FWD or BWD. If so, flow proceeds to node 198, otherwise flow proceeds to node 195.

At node 198 the variable MBTYPE is updated to indicate the macroblock includes all unidirectional motion vectors of the same type, such as forward motion vector. From node 198 flow proceeds to node 199 where the variable SUBMBTYPE is updated to indicate it is not applicable, as necessary, because MBMODE indicates a unidirectional macroblock. Flow proceeds from node 199 to node 195.

Returning to node 21 of FIG. 4, further video decoding is performed using the current set of motion vectors for the current macroblock. For example, the current set of motion vector information represented at FIG. 12, which can include a reduced set of motion vectors, are provided to the motion vector buffer 2511 of memory 215, where they can be retrieved by the IDE 104 for further decoding. Because the number of motion vectors can be reduced, the bandwidth needed to access the motion vectors for any given macroblock can be reduced.

At VPE, a predicted data processing engine accesses a previously rendered pixel image based upon a motion vector for use as a predicted image, while the residual data processing engine determines a residual pixel image that corresponds to the pixels of the predicted image based upon coefficients. The predicted pixel image and the residual pixel image are combined to form an unfiltered pixel image. The unfiltered pixel image can be filtered by the filtering module 244 to produce a filtered pixel image that can be accessed by a rendering engine to render an image.

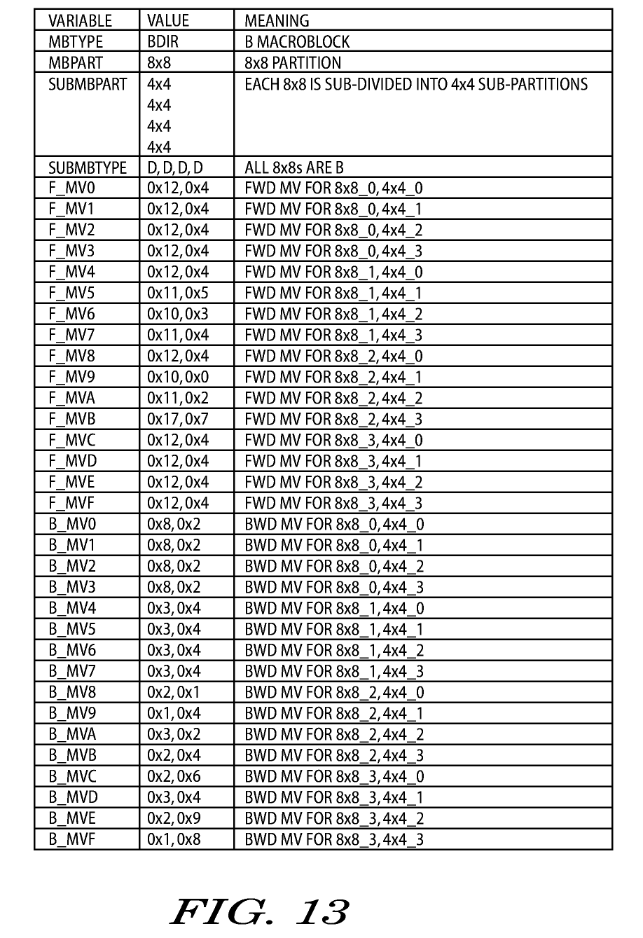

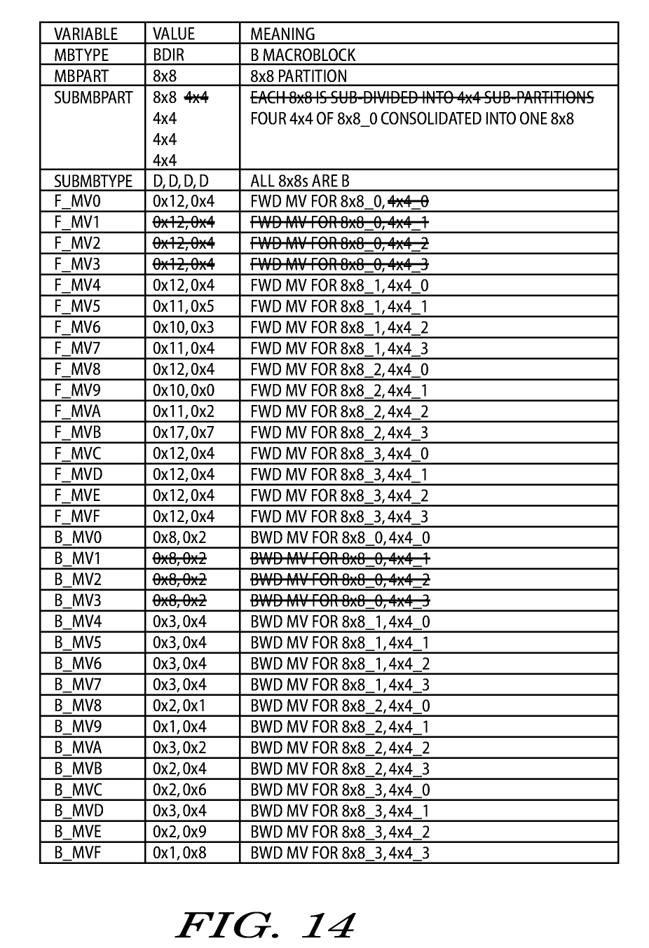

FIG. 13 illustrates a table representing information related to a bidirectional macroblock partitioned into four 8×8 blocks each representing a bidirectional block. Each of the four 8×8 block are bidirectional, as indicated by the value D, D, D, D, of variable SUBMBTYPE, and are further partitioned into four 4×4 blocks. Motion vectors beginning with “F_” are forward motion vectors, while motion vectors beginning with “B_” are backward motion vectors. Because each of the motion vectors associated with the first 8×8 block is the same, application of the flow chart of FIG. 4 results in the variable SUBMBPART being changed to 8×8, 4×4, 4×4, 4×4, and motion vectors F_MV1-F_MV3 and motion vectors B_MV1-B_MV3 being removed, as indicated by being struck through at FIG. 14. However, no further reduction in motion vectors can be accomplished for the macroblock represented by the information at the table of FIG. 14.

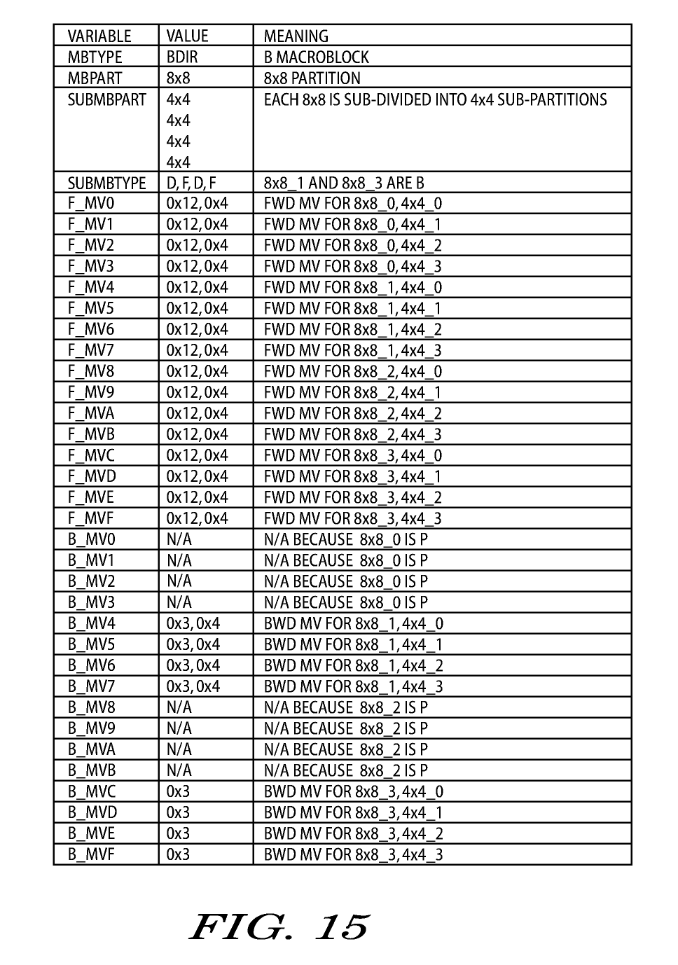

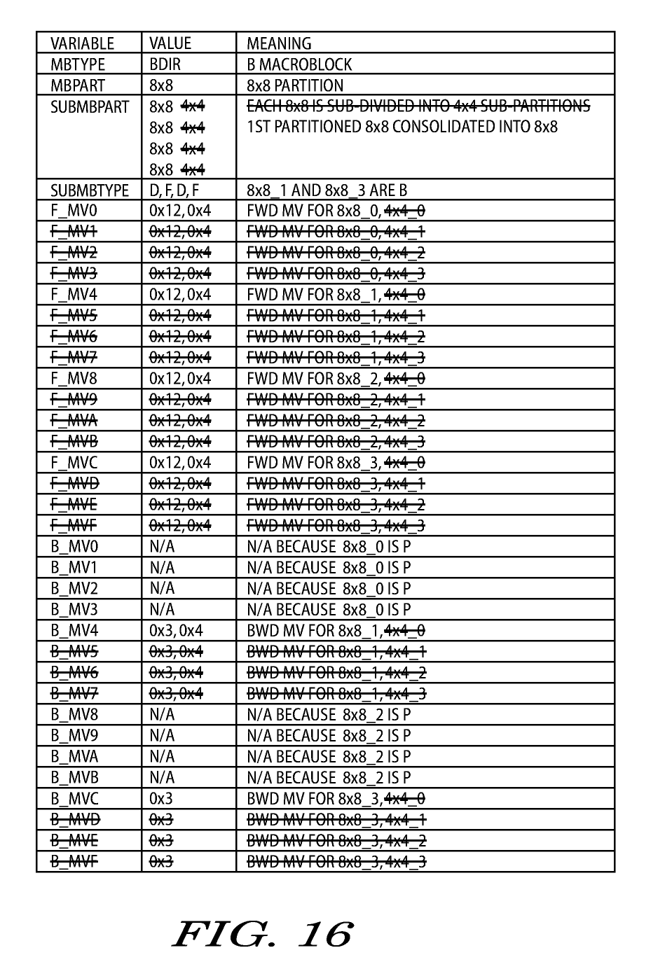

FIG. 15 illustrates a table representing information related to a bidirectional macroblock partitioned into four 8×8 blocks. The first and third 8×8 blocks each represent bidirectional blocks, as indicated by the bidirectional (D) indicators at the SUBMBTYPE variable, while the second and fourth 8×8 blocks each represent unidirectional forward type blocks, as indicated by the forward indicators (F) at the SUBMBTYPE variable. Each of the four 8×8 blocks are further partitioned into four 4×4 blocks. Because each of the 4×4 forward motion vectors associated with the first 8×8 block are the same motion vectors, F_MV1-F_MV3 are removed, and the variable SUBMBPART is updated to indicate the first 8×8 block is partitioned as an 8×8 block as illustrated at FIG. 16. Similarly, the third 8×8 block is updated to represent an 8×8 partitioned block as illustrated at FIG. 16. Because each of the 4×4 forward motion vectors associated with the second 8×8 block are the same motion vector and each of the 4×4 backward motion vectors associated with the second 8×8 block are the same motion vector, motion vectors F_MV5-F_MV7 and B_MV5-B_MV7 are not needed, and the variable SUBMBPART is updated to indicate the second 8×8 block is partitioned as an 8×8 block as illustrated at FIG. 16. Similarly, the third 8×8 block is updated to represent an 8×8 partitioned block as illustrated at FIG. 16. However, since the macroblock represented at FIG. 16 includes mixed unidirectional and bidirectional macroblock further 8×8 processing does not result in consolidation to a 16×16 macroblock.

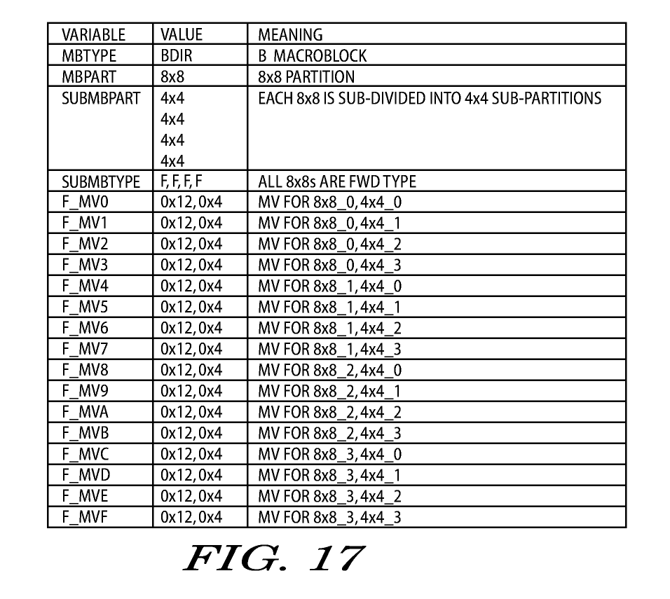

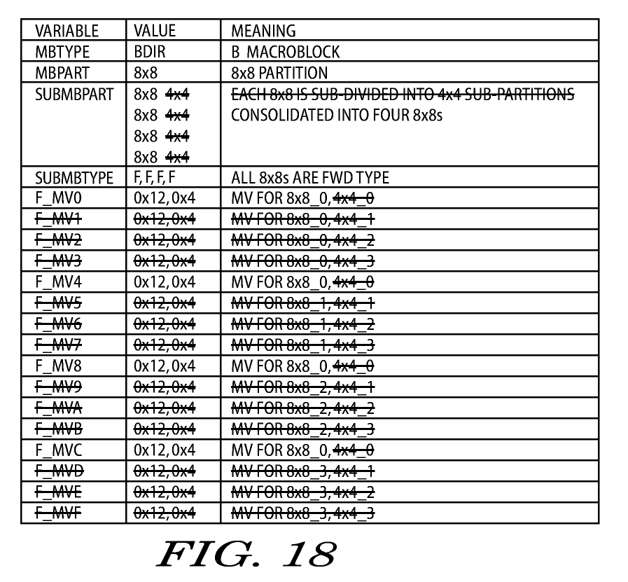

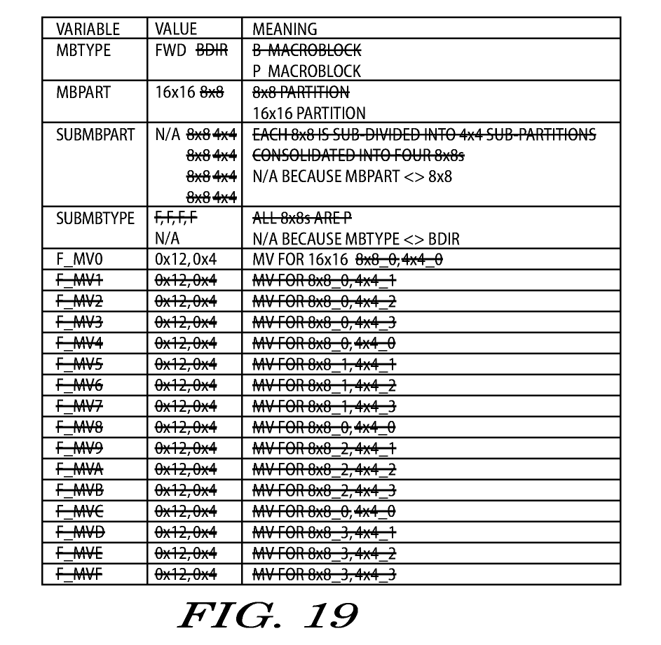

FIG. 17 illustrates a table representing information related to a bidirectional macroblock partitioned into four 8×8 blocks. Each of the four 8×8 blocks are further indicated to be unidirectional forward type blocks, as indicated by the indicators (F) at the SUBMBTYPE variable. Each of the four 8×8 blocks are further partitioned into four 4×4 blocks. Because each of the 4×4 forward motion vectors associated with each of the 8×8 blocks are the same motion vectors F_MV1-F_MV3, F_MV5-F_MV7, F_MV9-F_MVB, and F_MVD-F_MVF are removed and the variable SUBMBPART is updated to indicate each 8×8 macroblock is partitioned as an 8×8 macroblock as indicated at FIG. 18. Further 8×8 block processing, see node 199 of FIG. 11, results in the macroblock type (MBTYPE) being changed to indicate a forward predicted macroblock having a partition (MBPART) that has been changed to indicate a 16×16 macroblock, as illustrated at the table of FIG. 19. Note that variables SUBMBPART and SUBMBTYPE are not needed for a macroblock of type 16×16.

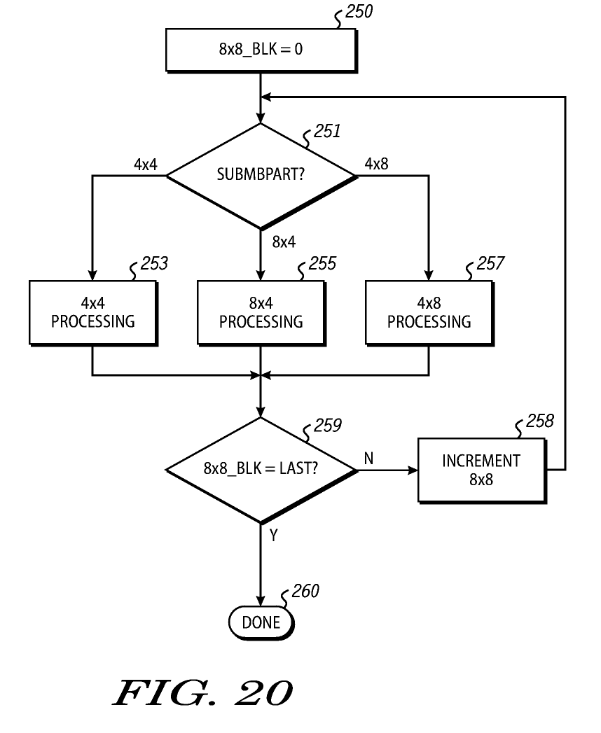

While the previous figures have described a specific embodiment for performing 8×8 block processing for 8×8 blocks that are further divided into 4×4 blocks. It will be appreciated that in addition to reducing the number of 4×4 blocks in a macroblock having 4×4 partitions the number of 8×4 or 4×8 blocks in a macroblocks having 8×4 or 4×8 partitions, respectively, can also be reduced. For example, referring to FIG. 20, a flow diagram is illustrated where based upon the variable SUBMBPART as determined at node 251 results in each 8×8 block being 4×4 processed at node 253, 8×4 processed at node 255, or 4×8 being processed at node 257. This repeats via node 259 until each of the 8×8 macroblock have been processed.

Note that not all of the activities described above in the general description or the examples are required, that a portion of a specific activity may not be required, and that one or more further activities may be performed in addition to those described. Still further, the order in which activities are listed is not necessarily the order in which they are performed. After reading this specification, skilled artisans will be capable of determining what activities can be used for their specific needs or desires. For example, while a specific embodiment has been described for processing 8×8 macroblock partitions, see node 13, it will be appreciated that other partitions, such as 8×16, and 16×18 partitions can also be processed as well to create larger block partitions. Also, it will be appreciated that information can be transferred between various functional modules either directly through conductive structures, indirectly through memory structures, or by other means. For example, the input of the motion vector reduction module 1131 can receive information from the motion vector decode module via buffer 2343, where buffer 2343 is implemented at memory 115. For example an input of memory 115 can receive information from an output of the motion vector decode module 2322, an output of memory 115 can provide the information to an input of the motion vector reduction module 1131, and the input of memory 115 can receive information from the motion vector reduction module 1131. Similarly, information can be provided from an output of memory 115 to an input of memory 131 via memory control 130 for receipt at the inputs other modules of the disclosure.

In the foregoing specification, principles of the invention have been described above in connection with specific embodiments. However, one of ordinary skill in the art appreciates that one or more modifications or one or more other changes can be made to any one or more of the embodiments without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof have been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

1. A device for decoding a video picture comprising:
a motion vector decode module comprising an input to receive encoded motion vector information for a macroblock of the video picture, and to determine a first set of motion vectors associated with a macroblock of the video picture based upon the motion vector information;
a motion vector decode module comprising an input coupled to the output of the motion vector decode module to receive the first set of motion vectors, and an output to provide a second set of motion vectors, the motion vector decode module to determine a second set of motion vectors, based on the first set of motion vectors, representing the macroblock, the second set having fewer motion vectors than the first set; and
a video processor comprising an input coupled to the output of the first motion vector decode module to receive the second set of motion vectors, the decode module to render the macroblock based upon the second set of motion vectors.

2. The device of claim 1, wherein the motion vector decode module, the motion vector module, and the video processor are disposed at a common integrated circuit.

3. The device of claim 1, wherein the video image is based upon the h.264 video standard.

4. The device of claim 1, where the motion vector decode module is to combine a plurality of blocks, representing a set of pixels of the macroblock, into a single block.

5. The device of claim 4, where the respective motion vector for each block of the plurality of blocks has the same value.

6. The device of claim 4, wherein the respective motion vector for each block of the plurality of blocks includes a corresponding unidirectional motion vector.

7. The device of claim 6, wherein the unidirectional motion vector is a forward motion vector.

8. The device of claim 4, wherein the respective motion vector for each block of the plurality of blocks includes a corresponding forward motion vector and a corresponding backward motion vector.

9. The device of claim 6, wherein the unidirectional motion vector is a backward motion vector.

10. The device of claim 1, wherein the input of the motion vector decode module coupled to the motion vector decode module further comprises
a first memory comprising an input and an output,
the input of the first memory coupled to the output of the motion vector decode module to receive the first set of motion vectors, and to the output of the motion vector decode module to receive the second set of motion vectors; and
the output of the first memory coupled to the input of the motion vector decode module.

11. The device of claim 10, wherein the input of the video processor is coupled to the output of the first memory to receive the second set of motion vectors.

12. The device of claim 10 further comprising:
a second memory comprising an input coupled to the output of the first memory to receive the second set of motion vectors, and an output coupled to the input of the video processor to provide the second set of motion vectors.

13. A method for decoding a video picture comprising:
receiving first information for a macroblock of a video picture, the first information being encoded information;
determining a first set of unidirectional motion vectors associated with a set of pixels of the macroblock, where each respective pixel of the set of pixels is associated with a corresponding one of the unidirectional motion vector of the first set of motion vectors;
determining a second set of motion vectors, based on the first set of motion vectors, associated with the set of pixels, the second set of motion vectors having fewer motion vectors than the first set, and where each respective pixel of the set of pixels is associated with a corresponding one of the unidirectional motion vector of the second set of motion vectors; and
determining pixel-mapped information for the macroblock based upon the second set of motion vectors.

14. The method of claim 13 wherein receiving the first information and determining the pixel-mapped information occur at a common integrated circuit.

15. The method of claim 13, wherein the first macroblock image is encoded in accordance with an h.264 video standard.

16. The method of claim 13, wherein determining the second set of motion vectors is part of combining a plurality of blocks of the macroblock into a larger single macroblock.

17. The method of claim 16, wherein combining the plurality of blocks of the macroblock into the larger block includes determining that unidirectional motion vectors corresponding to blocks of the plurality of blocks have the same value.

18. The method of claim 13 further comprising:
determining a first set of backward motion vectors associated with the set of pixels of the macroblock, where each respective pixel of the set of pixels is associated with a corresponding one of the backward motion vector of the first set of motion vectors; and
determining a second set of backward motion vectors, based on the first set of backward motion vectors, associated with the set of pixels, the second set of backward motion vectors having fewer motion vectors than the first set of backward motion vectors, and where each respective pixel of the set of pixels is associated with a corresponding one of the backward motion vectors of the second set of motion vectors.

19. The method of claim 13 further comprising:
determining a first set of forward motion vectors associated with the set of pixels of the macroblock, where each respective pixel of the set of pixels is associated with a corresponding one of the forward motion vector of the first set of motion vectors; and
determining a second set of forward motion vectors, based on the first set of forward motion vectors, associated with the set of pixels, the second set of forward motion vectors having fewer motion vectors than the first set of forward motion vectors, and where each respective pixel of the set of pixels is associated with a corresponding one of the forward motion vectors of the second set of motion vectors.

20. The method of claim 13 wherein determining the first set of unidirectional motion vectors includes storing the first set of unidirectional motion vectors at a first memory; and wherein determining the second set of unidirectional motion vectors includes storing the second set of motion vectors at a second memory; and wherein determining the pixel mapped information includes accessing the second set of unidirectional motion vectors from the second memory.
